(19) United States
(12) Patent Application Publication
(10) Pub. No.: US 2007/0178382 A1
(43) Pub. Date: Aug. 2, 2007

(54) Anode material for secondary battery, secondary batteries using the same, method for manufacturing anode material for secondary battery and secondary batteries using the same

(76) Inventors: Jong-Sung Kim, Gyeonggi-do (KR); Ho-Gun Kim, Seoul (KR); Dong-Hun Shin, Gyeonggi-do (KR); Chul Youm, Gyeonggi-do (KR); Jeong-Hun Oh, Gyeonggi-do (KR)

Correspondence Address: JONES DAY, 222 EAST 41ST ST, NEW YORK, NY, 10017, US

(21) Appl. No.: 11/698,938

(22) Filed: Jan. 26, 2007

(30) Foreign Application Priority Data
Jan. 27, 2006 (KR) 10-2006-0008883

(51) Int. Cl. H01M 4/62; H01M 4/64; H01M 4/58; C09C 1/56

(52) U.S. Cl. 429/232; 429/233; 429/231.8; 423/460

(57) ABSTRACT

Disclosed are an anode material for a secondary battery, a secondary battery using the same, a manufacturing method of the anode material for a secondary battery and a secondary battery using the same. The present invention provides an anode material for a secondary battery including an anode active material; and a coating material with which a surface of the anode active material is coated using a mixture of a conductive material and a pitch which is a low-crystallinity carbonaceous material, wherein the conductive material in the coating material is included in a content of 0.2% by weight or more of the anode active material and the low-crystallinity carbonaceous material. According to the present invention, the secondary battery having an excellent electrical property may be provided by preventing a charging/discharging efficiency and a charging/discharging capacity of the battery from being deteriorated, and simultaneously improving conductivity of the electrode.

### BACKGROUND OF THE INVENTION

1. Field of the Invention

The present invention relates to an anode material for a secondary battery, a secondary battery using the same, a method for manufacturing an anode material for a secondary battery and a secondary battery using the same, and more particularly to an anode material for a secondary battery capable of improving battery characteristics by coating a core carbonaceous material with a low-crystallinity carbonaceous material as well as a conductive material to improve conductivity of an electrode material, a secondary battery using the same, a method for manufacturing an anode material for a secondary battery and a secondary battery using the same.

2. Description of the Related Art

Recently, there have been increasing demands for a small-sized and lightweight secondary battery having a relatively high capacity, and this trend has been accelerated as electronic apparatuses using a battery, for example portable phones, portable notebook computers, electric vehicles, etc., comes into wide use.

Natural graphite, which is a crystalline carbonaceous material used for an anode active material of a secondary battery, has an excellent initial discharging capacity, but a charging/discharging efficiency and a charging/discharging capacity of the secondary battery are abruptly deteriorated as charge/discharge cycles of the secondary battery increase repeatedly. It was known that the above-mentioned problems are caused by a degradation reaction of electrolyte, which occurs partially at an edge of high-crystallinity natural graphite.

There have been some attempts to solve the problem on the deteriorated battery characteristics by coating natural graphite which is a crystalline carbonaceous material with a low-crystallinity carbonaceous material. However, there have been various technical restrictive factors, for example a demand of additional processes, difficulty to easily ensure desired physical properties, etc. In order to solve the problem that characteristics of the battery are deteriorated as an electrode resistance of an electrode material is raised, there has been proposed a method in which a conductive material is added in a manufacturing process of a slurry mixture for manufacturing an electrode material. However, the electrode resistance of the electrode material was not significantly improved, and therefore there has been a need for solving the technical limits.

Accordingly, there have been intensive attempts to solve both problems on the battery characteristics together by coating natural graphite with a low-crystallinity carbonaceous material as well as a conductive material, and the present invention was designed based on the above-mentioned facts.

### SUMMARY OF THE INVENTION

The present invention is designed to solve the problems of the prior art, and therefore it is an object of the present invention to provide an anode material for a secondary battery capable of preventing deterioration of a charging/discharging efficiency and a charging/discharging capacity of the secondary battery, which is caused by an degradation reaction of electrolyte that occurs in an interface of an anode active material and the electrolyte if natural graphite is used as the anode active material, and also improving conductivity of an electrode material, and a secondary battery using the same.

In order to accomplish the above object, the present invention provides an anode material for a secondary battery including an anode active material; and a conductive material with which a surface of the anode active material is coated, wherein the conductive material is included in a content of 0.2% by weight or more, based on the total weight of the anode active material.

In order to accomplish the above object, the present invention provides an anode material for a secondary battery including an anode active material; and a coating material with which a surface of the anode active material is coated using a mixture of a conductive material and a pitch which is a low-crystallinity carbonaceous material, wherein the conductive material in the coating material is included in a content of 0.2% by weight or more, based on the total weight of the anode active material and the low-crystallinity carbonaceous material.

In the case of the two anode materials for a secondary battery provided in the present invention as described above, the anode material for a secondary battery preferably has an electrode resistance of 2.0Ω or less, the anode active material is preferably natural graphite, and the conductive material is preferably at least one material selected from the group consisting of carbon black, Super-P and carbon nanotube.

In order to accomplish the above object, the present invention provides a secondary battery manufactured by using as a battery anode the anode material for a secondary battery that satisfies the requirements as described above. The secondary battery preferably has a discharging capacity of 330 mAh/g or more and a charging/discharging efficiency of 90% or more.

In order to accomplish the above object, the present invention provides a method for manufacturing an anode material for a secondary battery, including: (S1) preparing natural graphite which is a crystalline carbonaceous material, a pitch which is a low-crystallinity carbonaceous material, and a conductive material; (S2) mixing the prepared materials together to coat a crystalline carbonaceous material with the low-crystallinity carbonaceous material and the conductive material at the same time and drying the coated crystalline carbonaceous material; and (S3) calcining the dried product.

At this time, the crystalline carbonaceous material of the step (S1) is preferably natural graphite, and the conductive material of the step (S1) is at least one material selected from the group consisting of carbon black, Super-P and carbon nanotube. Meanwhile, the calcination of the step (S3) is preferably carried out at a different temperature in at least two steps, and the calcination process carried out in at least two steps is particularly preferably carried out at a relatively lower temperature in an initial calcination step and at a relatively higher temperature in a later calcination step.

In order to accomplish the above object, the present invention provides a secondary battery manufactured by using as a battery anode the anode material manufactured according to the manufacturing method as described above. At this time, the secondary battery has a discharging capacity of 330 mAh/g or more and a charging/discharging efficiency of 90% or more.

### BRIEF DESCRIPTION OF THE DRAWINGS

Other objects and aspects of the present invention will become apparent from the following description of embodiments with reference to the accompanying drawings. However, it should be understood that the description proposed herein is just a preferable example for the purpose of illustrations only, not intended to limit the scope of the invention. In the drawings:

FIG. 1 is a flow chart illustrating a process for manufacturing an electrode using an anode material for a secondary battery according to the present invention.

### DESCRIPTION OF THE PREFERRED EMBODIMENT

Hereinafter, preferred embodiments of the present invention will be described in detail referring to the accompanying drawings. However, the description proposed herein is just a preferable example for the purpose of illustrations only, not intended to limit the scope of the invention, so it should be understood that other equivalents and modifications could be made thereto without departing from the spirit and scope of the invention. The preferred embodiments of the present invention will be described in detail for the purpose of better understandings, as apparent to those skilled in the art.

In the present invention, a battery electrode plate with significantly improved conductivity may be manufactured by coating the battery electrode plate with a conductive material along with a low-crystallinity carbon in order to solve the problems on battery characteristics of natural graphite used for an anode active material of the battery.

### EMBODIMENTS 1 TO 4 AND COMPARATIVE EXAMPLES 1 AND 2

Natural graphite which is a crystalline carbonaceous material, and a pitch which is a low-crystallinity carbonaceous material were prepared as an anode material, and ketjen black which is a kind of carbon black was prepared as a conductive material, as classified into Embodiments 1 to 4 and Comparative example 1 in the following Table 1. Meanwhile, the conductive material was added in a different process in Comparative example 2, as described later in detail.

TABLE 1

| | | Crystalline | Low-crystallinity | | Addition time of |
|---|---|---|---|---|---|
| | | carbonaceous | carbonaceous | Conductive | Conductive |
| | | material | material | material | material |
| Embodiments | 1 | Natural | Pitch | Ketjen black | Along with |
| | | graphite | | 1.0 wt % | low-crystallinity |
| | | | | | carbon |
| | 2 | Natural | Pitch | Ketjen black | Along with |
| | | graphite | | 0.5 wt % | low-crystallinity |
| | | | | | carbon |
| | 3 | Natural | Pitch | Ketjen black | Along with |
| | | graphite | | 0.3 wt % | low-crystallinity |
| | | | | | carbon |
| | 4 | Natural | Pitch | Ketjen black | Along with |
| | | graphite | | 0.2 wt % | low-crystallinity |
| | | | | | carbon |
| Comparative | 1 | Natural | Pitch | Ketjen black | Along with |
| examples | | graphite | | 0.1 wt % | low-crystallinity |
| | | | | | carbon |
| | 2 | Natural | Pitch | Ketjen black | After |
| | | graphite | | 0.5 wt % | manufacturing |
| | | | | | anode material |

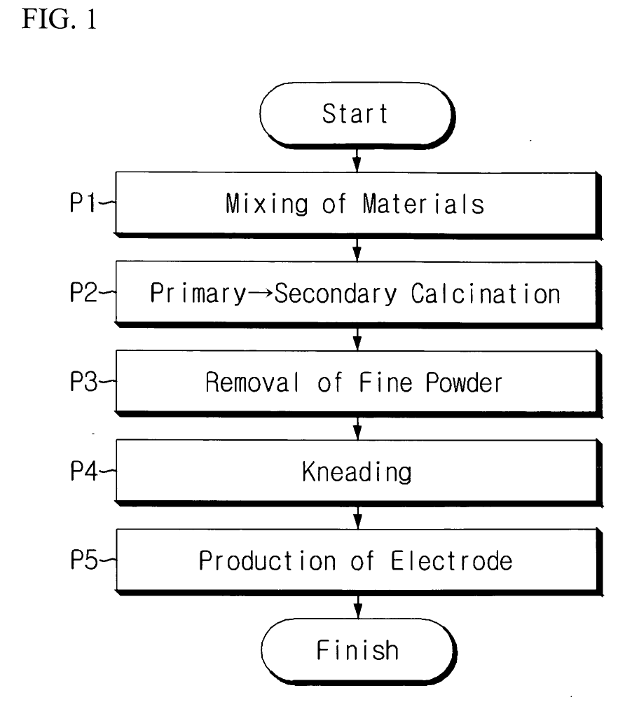

FIG. 1 is a flow chart illustrating a process for manufacturing an electrode using an anode material for a secondary battery according to the present invention. Hereinafter, a test electrode was manufactured according to steps P1 to P5 to evaluate battery characteristics of the anode material for a secondary battery according to the present invention.

Mixing of Materials (P1): Pitch dissolved in tetrahydrofuran (THF) was added at a constant weight ratio to spherical natural graphite which is a core carbonaceous material, and ketjen black which is a kind of carbon black was added as a conductive material in a content as listed in the Table 1, and they were homogeneously mixed for 2 hours by means of wet-stirring under an ambient pressure, and then dried, as classified into Embodiments 1 to 4 and Comparative example 1 in the Table 1.

Calcination (P2): The dried product was sequentially calcined firstly at 1,100° C. for 1 hour and secondly at 1,500° C. for 1 hour.

Removal of Fine Power (P3): After the 2-step calcination process, the calcined materials are distributed to remove a fine powder.

Kneading (P4): 100 g of a mixture of a pitch and a graphite-based carbonaceous material which is the fine powder-free anode material was put into a 500 ml vial, and a small amount of N-methylpyrrolidone (NMP) and polyvinylidene fluoride (PVDF) were added thereto as a binder, and they were then kneaded using a mixer.

Production of Electrode (P5): Finally, the resultant mixture was pressed on a copper foil, and then dried to obtain a test electrode.

Meanwhile, in the case of Comparative example 2, the conductive material was added in the different manner from that as described above. That is, pitch dissolved in tetrahydrofuran (THF) was added at a constant weight ratio to spherical natural graphite which is a core carbonaceous material, the resultant mixture was sequentially calcined firstly at 1,100° C. for 1 hour and secondly at 1,500° C. for 1 hour, and then the calcined materials are distributed to remove a fine powder. Based on 100 g of the mixture of the pitch and the graphite-based carbonaceous material which is an anode material manufactured as described above, 0.5% by weight of ketjen black was added as the conductive material to a 500 ml vial, and a small amount of N-methylpyrrolidone (NMP) and polyvinylidene fluoride (PVDF) were added thereto as a binder, and they were then kneaded using a mixer. Finally, the resultant mixture was pressed on a copper foil, and then dried to obtain a test electrode.

Evaluation of Physical Properties

The electrodes manufactured according to the Embodiments 1 to 4 and the Comparative examples 1 and 2 had a tap density of 1.5 g/cm³, and an electrode thickness of 70 μm, and the manufactured test electrodes were measured for an electrode resistance, respectively, using a resistance tester (mΩ Meter), and coin cells were manufactured to measure an initial discharging capacity and a charging/discharging efficiency, and the results are listed in the following Table 2.

Each of the test electrodes was dried under a vacuum for at least 12 hours, and cut into a length of 15 cm in a dry room, and then a resistance tester (ADEX, Ax-126B) was connected to both ends of each of the test electrodes to measure an electrode resistance.

The charge/discharge test in the battery using each of the test electrodes was carried out by limiting an electric potential to a range of 0 to 1.5 V. That is, a secondary battery was charged with a charging current of 0.5 mA/cm² to a voltage of 0.01 V, and then continuously charged to a charging current of 0.02 mA/cm² while maintaining the voltage of 0.01 V. And, the secondary battery was then discharged with a discharging current of 0.5 mA/cm² to a voltage of 1.5 V. In the following Table 2, the first charging/discharging efficiency is represented by percentage of a discharging capacity to a charging capacity.

TABLE 2

| | | Electrode | First | First Charging/ |
|---|---|---|---|---|
| | | Resistance | Discharging | Discharging |
| | | (Ω) | Capacity | Efficiency |
| Embodiments | 1 | 0.9 | 356.2 | 94.3 |
| | 2 | 1.4 | 353.5 | 93.2 |
| | 3 | 1.7 | 352.7 | 92.9 |
| | 4 | 1.9 | 351.4 | 92.5 |
| Comparative | 1 | 2.3 | 348.2 | 91.9 |
| Examples | 2 | 2.2 | 349.8 | 92.2 |

As seen in the Table 2, the discharging capacity or the charging/discharging efficiency of the secondary battery was proven to be rather good in all of the embodiments and the comparative examples, but the electrode resistance was measured to be higher in the Comparative examples 1 and 2 than in the Embodiments 1 to 4. Accordingly, it was seen that an addition time point of the conductive material directly affects conductivity of the electrode material since an electrode resistance value may be varied depending on the addition time point of the conductive material although the conductive material is added in the process for manufacturing an electrode.

As described in the embodiments according to the present invention, it was revealed that the electrode resistance is lowered as a content of the used conductive material increases. And, it was also seen that, if an amount of the added conductive material is identical but an addition time point of the conductive material is different, that is if the electrode resistances of the Embodiment 2 and Comparative example 2 were compared with each other, there was a large difference between the electrode resistance values and there was a slight difference in the discharging capacity and the charging/discharging efficiency, but the battery characteristics were more improved in the Embodiment 2 than in the Comparative example 2.

Meanwhile, it was revealed that the electrode resistance values were not deteriorated, and the battery characteristics were also hardly improved if the conductive material was used at an insufficient content to exhibit a significant effect (Comparative example 1).

As described above, the best embodiments of the present invention are disclosed. Therefore, the specific terms are used in the specification and appended claims, but it should be understood that the description proposed herein is just a preferable example for the purpose of illustrations only, not intended to limit the scope of the invention.

### APPLICABILITY TO THE INDUSTRY

As described above, the anode material for a secondary battery according to the present invention may be useful to improve conductivity of the electrode by preventing deterioration of the conventional battery characteristics that the natural graphite which is a crystalline carbonaceous material exhibits, as well as by improving an electrode resistance of the electrode material. Accordingly, the secondary battery having an excellent electrical property may be provided by preventing deterioration of a charging/discharging efficiency and a charging/discharging capacity of the battery manufactured according to the present invention, and simultaneously improving conductivity of the electrode.

What is claimed is:

1. An anode material for a secondary battery comprising:
an anode active material; and
a conductive material with which a surface of the anode active material is coated,
wherein the conductive material is included in a content of 0.2% by weight or more, based on the total weight of the anode active material.

2. The anode material for a secondary battery according to claim 1,
wherein the anode material for a secondary battery has an electrode resistance of 2.0Ω or less.

3. The anode material for a secondary battery according to claim 1, wherein the anode active material is natural graphite.

4. The anode material for a secondary battery according to claim 1,
wherein the conductive material is at least one material selected from the group consisting of carbon black, Super-P and carbon nanotube.

5. An anode material for a secondary battery comprising:
an anode active material; and
a coating material with which a surface of the anode active material is coated using a mixture of a conductive material and a pitch which is a low-crystallinity carbonaceous material,
wherein the conductive material in the coating material is included in a content of 0.2% by weight or more, based on the total weight of the anode active material and the low-crystallinity carbonaceous material.

6. The anode material for a secondary battery according to claim 5,
wherein the anode material for a secondary battery has an electrode resistance of 2.0Ω or less.

7. The anode material for a secondary battery according to claim 5,
wherein the anode active material is natural graphite.

8. The anode material for a secondary battery according to claim 5,
wherein the conductive material is at least one material selected from the group consisting of carbon black, Super-P and carbon nanotube.

9. A secondary battery manufactured by using, as a battery anode, the anode material for a secondary battery as defined in claim 1.

10. The secondary battery according to claim 9,
wherein the secondary battery has a discharging capacity of 330 mAh/g or more and a charging/discharging efficiency of 90% or more.

11. A secondary battery manufactured by using, as a battery anode, the anode material for a secondary battery as defined in claim 5.

12. The secondary battery according to claim 11,
wherein the secondary battery has a discharging capacity of 330 mAh/g or more and a charging/discharging efficiency of 90% or more.

13. A method for manufacturing an anode material for a secondary battery, comprising:
(S1) preparing natural graphite which is a crystalline carbonaceous material, a pitch which is a low-crystallinity carbonaceous material, and a conductive material;
(S2) mixing the prepared materials together to coat a crystalline carbonaceous material with the low-crystallinity carbonaceous material and the conductive material at the same time and drying the coated crystalline carbonaceous material; and
(S3) calcining the dried product.

14. The method for manufacturing an anode material for a secondary battery according to claim 13,
wherein the crystalline carbonaceous material of the step (S1) is natural graphite.

15. The method for manufacturing an anode material for a secondary battery according to claim 13,
wherein the conductive material of the step (S1) is at least one material selected from the group consisting of carbon black, Super-P and carbon nanotube.

16. The method for manufacturing an anode material for a secondary battery according to claim 13,
wherein the calcination of the step (S3) is carried out at different temperatures in at least two steps.

17. The method for manufacturing an anode material for a secondary battery according to claim 16,
wherein the calcination process carried out in at least two steps is carried out at a relatively lower temperature in an initial calcination step and at a relatively higher temperature in a later calcination step.

18. A secondary battery manufactured by using, as a battery anode, the anode material manufactured according to the method as defined in any of claims 13.

19. The secondary battery according to claim 18,
wherein the secondary battery has a discharging capacity of 330 mAh/g or more and a charging/discharging efficiency of 90% or more.
